(19) United States
(12) Patent Application Publication
(10) Pub. No.: US 2023/0374711 A1
(43) Pub. Date: Nov. 23, 2023

(54) NONWOVEN WEB COMPRISING POLYLACTIC ACID, ITS MANUFACTURING PROCESS AND FOOD PACKAGING COMPRISING SUCH A NONWOVEN WEB

(71) Applicant: AHLSTROM- OYJ, Helsinki (FI)

(72) Inventors: Emilie Picard, Estrablin (FR); Patrice Blanc, Saint-Genis-Laval (FR); Raymond Volpe, Windsor Locks, CT (US)

(21) Appl. No.: 18/030,884

(22) PCT Filed: Oct. 8, 2021
(86) PCT No.: PCT/FI2021/050670

§ 371 Date: Apr. 7, 2023

(30) Foreign Application Priority Data
Oct. 9, 2020 (FR) 2010366

(51) Int. Cl. D04H 1/559; D04H 3/011; D04H 3/147

(52) U.S. Cl. CPC D04H 1/559; D04H 3/011; D04H 3/147; D10B 2331/041; D10B 2505/10

(57) ABSTRACT

A heat-resistant nonwoven melt-bonded web, in particular by spun bonding, comprising at least: —a first layer comprising first fibers —a second layer comprising second fibers in which at least one of the first fibers of the first layer (1) or the second fibers of the second layer (2) comprise a polylactic acid stereocomplex representing at least 20% by volume relative to the total volume of the constituents of the first or second fibers.

### TECHNICAL FIELD OF THE INVENTION

The present invention relates to nonwoven webs comprising bio-based materials, and in particular polylactic acid.

In particular, the invention relates to a nonwoven web suitable for use in the field of packaging for hot drinks such as tea bags, infusion bags or coffee pods. The invention also relates to a nonwoven web suitable for forming packaging intended for cooking food in water. The invention also relates to a process of manufacturing such a nonwoven web.

### STATE OF THE ART

In order to improve the sustainable management of certain packaging, there is a growing interest in bio-based materials. These materials can have a lower carbon footprint than those from fossil resources such as polyethylene terephthalate (PET), polypropylene (PP), polyamide (PA), for example. In addition, materials with improved biodegradability compared to other conventional plastic materials, especially those from petrochemicals, are also considered during the development of new products, including consumer single-use products.

Polylactic acid is a bio-based material which is, moreover, compostable under certain conditions. Polylactic acid is a polyester obtained during the condensation polymerization of lactic acid. Lactic acid is obtained by fermentation of sugars from carbohydrate sources such as corn or sugar cane, for example.

Nonwoven packaging is used in particular for tea infusions, for coffee pods or even for cooking certain foods. In order to provide a compostable product under industrial conditions, in particular according to ASTM D6400 and EN 13432 standards, before or after use, nonwoven web packaging comprising polylactic acid is currently offered on the market.

Heat-sealable nonwoven webs based on polylactic acid are known in the market. However, this product is not entirely satisfactory, especially for applications requiring exposure to hot or boiling water for an extended period of time.

Document JP 2009133022 describes a woven web comprising a polylactic acid stereocomplex. This woven web is obtained by a first step of manufacturing yarns comprising a polylactic acid stereocomplex followed by a weaving step.

Document WO 2009/042837 describes a process for manufacturing bicomponent fibers comprising a polylactic acid stereocomplex. This process requires having two separate extruders to form the portion of the fibers comprising the polylactic acid stereocomplex, which further complicates the manufacturing process of the fibers.

Therefore, there is a need to provide nonwoven webs derived from bio-based materials, in particular based on polylactic acid, these nonwoven webs possibly being biodegradable and/or compostable and having improved thermal and mechanical strength properties.

The aim of the invention is to, at least partially, satisfy this need, while preserving the compostability of nonwoven webs comprising polylactic acid.

### DISCLOSURE OF THE INVENTION

According to the invention, this object is achieved by means of a heat-resistant nonwoven web produced by melt-bonding, in particular by spun bonding, comprising at least:
a first layer comprising first fibers
a second layer comprising second fibers in which at least one of the first fibers of the first layer or the second fibers of the second layer are advantageously spunbonded fibers and comprise a polylactic acid stereocomplex representing at least 20% by volume of the total volume of the first or second fibers.

A melt-bonding process comprises in particular the spun-bonding and melt-blowing processes. These processes are advantageous because the fiber formation and the bonding steps are carried out online in the same process, the fibers form almost continuously the nonwoven. Thus, the nonwoven is obtained directly in a single process.

The spun bonding process makes it possible to manufacture spun-bonded fibers commonly called “spunbond” fibers in the state of the art, i.e., fibers formed by extruding a molten material in the form of fibers through the orifices of a spinneret, said fibers being drawn in particular by air jet, deposited on a topping table then bound together, preferably by calendering.

The melt-blowing process makes it possible to manufacture melt-blown fibers, as commonly known in the prior art. As with the spun bonding process, fibers are formed by extruding a molten material through the orifices of a spinneret. However, this process differs from the spun bonding process in particular by the temperature and the volume of air used for drawing the fibers, as well as the location where the air jet comes into contact with the material exiting the spinnerets. For a melt-blowing process, the air temperature is generally high and the air jet comes into contact with the molten material at the spinnerets.

The term “nonwoven” is understood to mean any web of fibers interwoven at random, with the difference, for example, of the arrangement of the fibers constituting a woven fabric or a knitted fabric.

The term “web” is understood to mean a fibrous material capable of being wound into a roll. The expression “polylactic acid stereocomplex” is understood to mean a polylactic acid polymer having a crystalline structure with a melting point higher than that of levorotatory or dextrorotatory polylactic acid alone, such a polylactic acid stereocomplex being obtained by a mixture of levorotatory polylactic acid and dextrorotatory polylactic acid.

The term “heat-resistant” nonwoven is understood to mean a nonwoven comprising a polylactic acid stereocomplex having a melting point of at least 200° C., and preferably between 210 and 220° C. As a result, this nonwoven will have a sealing temperature between 130 and 210° C. while the conventional nonwovens comprising polylactic acid devoid of polylactic acid stereocomplex, have a sealing window between 130 and 150° C.

A nonwoven web according to the present invention exhibits improved mechanical properties, in particular, thanks to the presence of the polylactic acid stereocomplex. This makes it possible to transform or shape a nonwoven according to the present invention by a downstream process operating at a higher speed than usual with a conventional nonwoven comprising polylactic acid.

In addition, the nonwoven web exhibits better resistance when exposed to hot or boiling water for a relatively long period of time.

The first layer can be stacked directly on the second layer, therefore resting entirely on this layer. The heat-resistant nonwoven web is preferably a bilayer assembly, in particular formed of a first layer comprising first fibers and a second layer comprising second fibers.

The first fibers and/or the second fibers may have a cross section presenting a shell-core structure and, more particularly, chosen from a core-shell structure, eccentric core-shell structure or islands in the sea, the core-shell structure being preferred. The shell part is therefore the sheath or sea part of the first or second fibers and the core part is therefore the core or island part of the first or second fibers.

Thus, preferably the shell is the part which includes the stereocomplex but it is possible to have a stereocomplex at the nucleus level. It is also possible to have a stereocomplex at the shell and the core.

The shell-core volume ratio may be at least 20/80, preferably this ratio is between 20/80 and 80/20, more preferably between 30/70 and 70/30 and even more preferably close to 50/50 or even equal to 50/50.

The first fibers and the second fibers may further be single-component fibers, i.e., fibers having a single portion. The first fibers and the second fibers may also be two-component having in particular a cross-sectional first portion and second portion.

The nonwoven according to the present invention may be compostable under industrial conditions. In this case, the nonwoven decomposes over time, in particular thanks to the action of microorganisms in the presence or absence of oxygen. The nonwoven according to the invention is, in particular, likely to meet the ASTM D6400 or EN 13432 standards by adapting the basis weight of the nonwoven.

Advantageously, the first fibers, on the one hand, and the second fibers, on the other hand, have a different melting point. The difference of these fiber melting temperatures is at least 20° C.

This temperature difference is useful, for example, when a nonwoven web assembly according to the present invention is shaped by heat-sealing for food packaging applications.

According to a particular embodiment, the first fibers and/or the second fibers comprise:
the first portion comprising a polylactic acid stereocomplex representing between 20 and 80% by volume, preferably between 30 and 70% by volume, and more preferably equal to 50% by volume relative to the total volume of the first or second fibers, and
a second portion comprising a second polymer, preferably with between 20 and 80% by volume, preferably between 30 and 70% by volume and more preferably equal to 50% by volume relative to the total volume of the first or second fibers, the second polymer being also chosen from polyhydroxyalkanoates, polyesters or their copolymers, polyesters being chosen in particular from polylactic acids, with the exception of polylactic acid stereocomplexes, polybutylene succinates, polybutylene succinate co-adipates, polycaprolactones, polybutyrate adipate terephthalates. A person skilled in the art will understand a portion of the fibers to be a continuous portion of the fibers. For example, a first portion may be the shell portion, i.e., the sheath or sea portion of the first or second fibers. Likewise, a second portion may be the core portion, i.e., the core or island portion of the first or second fibers.

Preferably, at least one of the first fibers or the second fibers have a diameter of less than 30 μm, and more preferably between 12 and 20 μm.

The nonwoven web according to the present invention may have a porosity of between 1000 l/m²/min and 9000 l/m²/min. The porosity of a nonwoven is measured according to DIN 53887. According to a particular embodiment, the nonwoven web has a basis weight of between 10 g/m² and 50 g/m², and more preferably between 15 g/m² and 30 g/m². This basis weight of the nonwovens being determined according to the ISO 536-2012 standard.

The nonwoven web according to the present invention may have a thickness between 60 microns and 180 microns, and preferably between 90 microns and 150 microns. Preferably, this thickness is substantially uniform over the entire web.

The first fibers and the second fibers may also comprise at least one additive such as, for example, a polymeric plasticizer or an antistatic agent. These fibers may comprise at least 10% by volume of this additive.

The invention also relates to a process for manufacturing a heat-resistant nonwoven web according to the present invention, the manufacturing process comprising the following steps:
a/supplying a spun bonding device with at least a dry mixture of a polymer of levorotatory polylactic acid and of a dextrorotatory polylactic acid polymer so as to form at least one fiber of the first layer or the second layer;
b/where appropriate, supplying at least one fiber of the first layer or the second layer not formed in step a/,
c/assembling the first and the second layers of which at least one fiber is formed in step a/and where appropriate, supplied in step b/.

The term “dry mixture” is understood to mean a mixture of at least two types of non-melted or non-solubilized solids. This type of mixture is commonly referred to as a “dry-blend”. For example, a “dry-blend” may be obtained by mixing at room temperature two types of granules or powders in the solid state.

Having as a starting material a dry-blend of a compound enriched in levorotatory polylactic acid and a compound enriched in dextrorotatory polylactic acid makes it possible to form a polylactic acid stereocomplex in the spun bonding device, more particularly at the fiber spinning step. This is particularly advantageous because the direct spinning of the polylactic acid stereocomplex is not easy. Indeed, when using a polylactic acid stereocomplex directly as a starting material, the temperature required to melt the granules is relatively high. The material, once melted, has a very low viscosity which makes it very difficult to draw and generates breakage of the filaments.

In the dry-blend, the volume ratio between the levorotatory polylactic acid polymer and the dextrorotatory polylactic acid polymer is preferably between 65/35 and 35/65, and more preferably between 60/40 and 40/60, and again more preferably between 55/45 and 45/55. The ratio may also be close to 50/50 or be equal to 50/50.

These ratios make it possible, in particular, to optimally form the stereocomplex in the fibers while minimizing the formation of other products which are not a polylactic acid stereocomplex.

The process of the invention is easy to implement compared to the solutions proposed in the state of the art. The process according to the invention makes it possible to obtain a nonwoven in a single step, unlike the process described in document JP 2009/042837. The fiber formation and the bonding steps are carried out online in the same process, the fibers form almost continuously the nonwoven. The process may be implemented in a device operating by the melt-bonding process and, more particularly, in a spun bonding device with a minimum of modification.

According to a first particular embodiment, the device operating by the melt-bonding process is a spun bonding device and at least the following steps are implemented in such a device:
a1/ supplying one or more extruders with the starting materials which may be in the form of granules or powders;
a2/ melting the starting materials in the extruders and conveying the molten materials to the spinnerets so as to form fibers;
a3/ partial cooling and drawing of the fibers leaving the spinnerets;
a4/ depositing the fibers on a topping table which may be a belt conveyor;

After step a4/, the fibers may pass through a calender in order to bind the fibers in a bonding step.

According to another particular embodiment, the device operating by the melt-bonding process is a melt-blowing device. In such a device, at least the following steps are implemented:
a1′/ supplying one or more extruders with the starting materials which may be in the form of granules or powders;
a2′/ melting the starting materials in the extruders and conveying the molten materials to the spinnerets so as to form fibers;
a3′/ drawing of fibers by hot air jet at the spinnerets;
a4′/ depositing the fibers on a collector screen which may be cylindrical.

After step a4′/, the fibers may also pass through a calender in order to bond the fibers in a bonding step.

According to a first variant, step b/ is implemented in the same device operating by the melt-bonding process as that of step a/, but with an independent supply of raw material and so as to form one of the first layer or the second layer not formed in step a/.

According to a second variant, step c/ of assembling the first layer and the second layer is implemented in the device operating by the melt-bonding process during the bonding step.

These two variants may be particularly useful when the first fibers and the second fibers are spun in the same device operating by the melt-bonding process having two sets of spinnerets, one of which is dedicated to the spinning of the first fibers and the other is dedicated to the spinning of the second fibers. Thus, a nonwoven web according to the invention may be obtained with a minimum of steps.

In order to improve the spinning of the fibers comprising the polylactic acid stereocomplex according to the present invention, the molten material may be at a temperature between 200° C. and 280° C., preferably between 210° C. and 260° C., and more preferably at a temperature between 220° C. and 235° C. at the extruder outlet.

Step a3/ is preferably carried out by air jet. The drawing of the fibers may be carried out at a speed of between 2000 and 7000 m/min.

Finally, the invention relates to a food packaging intended to be immersed in an aqueous solution having a temperature of at least 90° C., comprising a heat-resistant nonwoven web according to the present invention.

A food packaging according to the present invention may be closed by heat sealing. If, for example, the second layer comprises fibers with a lower melting point than that of the fibers of the first layer, this second layer constitutes, in this particular example, the internal surface of the food packaging. The outer surface of the packaging will therefore consist of the first layer. Thus, the second layer is the one that will be melted or softened at the sealing points while the first layer acts as an insulator and avoids direct contact between the sealing jaws and the second layer.

However, it is also possible to close a food packaging according to the present invention by mechanical means, for example using a thread or a staple.

Due, in particular, to the presence of the polylactic acid stereocomplex, a nonwoven web according to the present invention may be transformed into a food packaging at a higher speed than that used with a nonwoven web based on conventional polylactic acid. Indeed, a nonwoven web according to the invention has improved mechanical properties at elevated temperatures and therefore better withstands the stresses undergone during its transformation or even its shaping, in particular, due to the increase in the melting temperature of the fibers bound thanks to the presence of PLA stereocomplex in these fibers.

Moreover, a nonwoven web according to the invention may be sealed with more force because it is more mechanically resistant. Therefore, the seals obtained can be more robust.

Therefore, a food packaging according to the invention can be exposed to hot or boiling water for a relatively long period of time compared to a nonwoven web (based on polylactic acid) known from the prior art.

### BRIEF DESCRIPTION OF THE FIGURES

Other advantages of the present invention will emerge more clearly on reading the following description, given by way of illustration and without limitation, and the accompanying drawings in which:

FIG. 1A is a schematic representation of a state-of-the-art nonwoven web;

FIG. 1B is a schematic representation of a nonwoven web according to the present invention;

FIG. 1C is a schematic representation of a nonwoven web according to the present invention;

FIG. 1D is a schematic representation of a nonwoven web according to the present invention;

FIG. 1E is a schematic representation of a nonwoven web according to the present invention;

FIG. 1F is a schematic representation of a nonwoven web according to the present invention;

FIG. 1G is a schematic representation of a nonwoven web according to the present invention;

FIG. 1H is a schematic representation of a nonwoven web according to the present invention;

FIG. 1I is a schematic representation of a nonwoven web according to the present invention;

FIG. 2 is an image of fibers of a nonwoven according to the invention obtained under a scanning electron microscope;

FIG. 3 is a schematic representation of the spinning step of a process according to the present invention;

FIG. 4 is a schematic representation of a sealing point of a food packaging according to the present invention;

FIG. 5A are photographs of Sample 1 sealed at different temperatures;

FIG. 5B are photographs of Sample 2 sealed at different temperatures;

FIG. 5C are photographs of Sample 3 sealed at different temperatures;

FIG. 5D are photographs of Sample 4 sealed at different temperatures;

FIG. 6 is a graph which represents the loosening rate over time of samples with twelve sealing points.

### DETAILED DESCRIPTION

In the following description, reference is made to first and second layers. This is a simple indexing to differentiate and name similar, less non-identical elements. This indexing does not imply a priority of one element over another and such names may easily be interchanged without departing from the scope of the present description. Neither does this indexing imply an order in time or in space to assess the positioning or action of these elements.

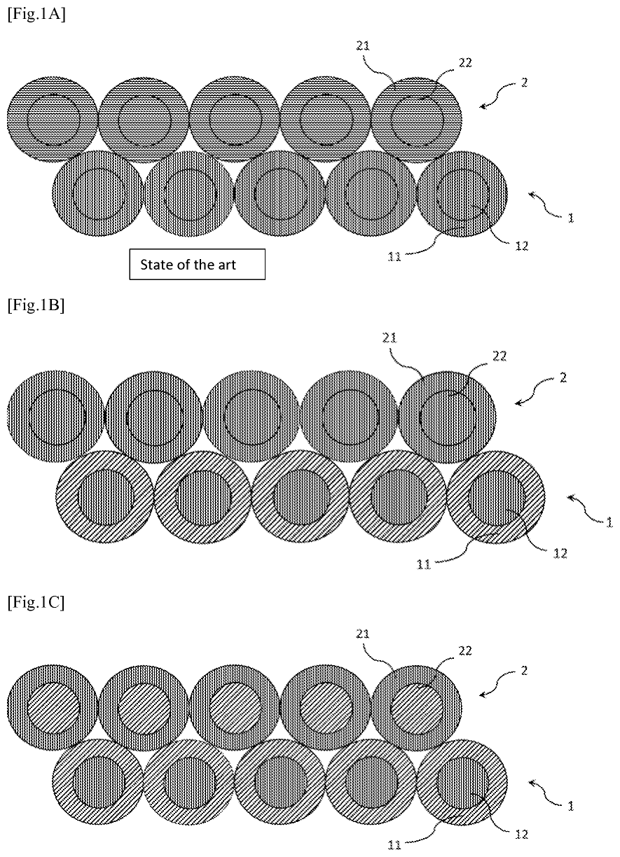

In FIGS. 1A-1I, the fiber sections appear to show parallel fibers, while, in reality, the fibers within a layer are randomly intertwined.

The fibers of the first layer 1 and the second layer 2 have a section with a core-sheath structure. FIG. 1A shows a nonwoven web according to the state of the art and FIGS. 1B to 1I show nonwoven webs according to the invention.

In FIG. 1A, the fibers of the first layer 1 have a core 12 and a sheath 11 made of levorotatory polylactic acid having a melting point of between 160° C. and 180° C. which will be designated PLA 1. The fibers of the second layer, for their part, have a core 22 in PLA 1 and a sheath 21 made of polylactic acid having a melting point of between 120° C. and 130° C. which will be designated amorphous PLA2. Therefore, this type of nonwoven web has a sealing window of between 130° C. and 150° C. In all instances, PLA1 and PLA2 do not contain a polylactic acid stereocomplex. FIG. 1B shows a nonwoven web according to the present invention. The core 12 of the first layer, as well as the core 22 and the sheath 21 of the second layer, are made of PLA 1 with a melting point of between 160° C. and 180° C. The sheath of the first layer consists of a polylactic acid stereocomplex which will be referred to as PLA STR having a melting point around 220° C. This nonwoven has a sealing window of between 180° C. and 210° C.

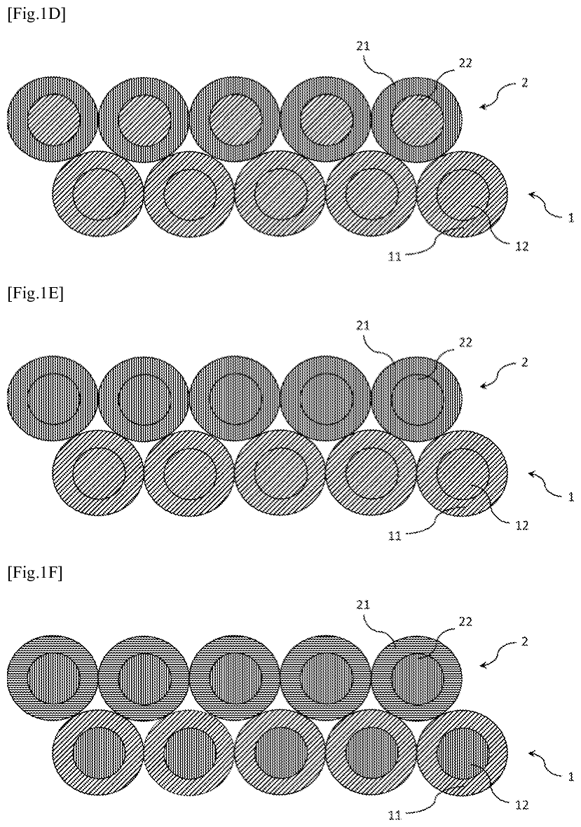

FIG. 2 shows the fibers of a nonwoven web according to the invention. The images A and B are identical and in the image B the delimitation between the core 12 and the sheath 11 was added to the image.

Other arrangements of nonwoven webs having a sealing window between 180° C. and 210° C. are shown with reference to FIGS. 1C to 1E. Table 1 summarizes the compositions of these different nonwoven webs.

It is also possible to have nonwoven webs with a broader sealing window between 130° C. and 210° C. This type of nonwoven webs is shown in FIGS. 1F to 1I and the layer compositions are summarized in Table 1. They offer more possibilities in terms of use.

TABLE 1

| | First layer 1 | | First layer 2 | | |
|---|---|---|---|---|---|
| | Core | Sheath | Core | Sheath | Sealing window |
| FIG. 1A | PLA 1 | PLA 1 | PLA 1 | PLA 2 | 130° C.-150° C. |
| FIG. 1B | PLA 1 | PLA STR | PLA 1 | PLA 1 | 180° C.-210° C. |
| FIG. 1C | PLA 1 | PLA STR | PLA STR | PLA 1 | 180° C.-210° C. |
| FIG. 1D | PLA STR | PLA STR | PLA STR | PLA 1 | 180° C.-210° C. |
| FIG. 1E | PLA STR | PLA STR | PLA 1 | PLA 1 | 180° C.-210° C. |
| FIG. 1F | PLA 1 | PLA STR | PLA 1 | PLA 2 | 130° C.-210° C. |
| FIG. 1G | PLA STR | PLA STR | PLA 1 | PLA 2 | 130° C.-210° C. |
| FIG. 1H | PLA STR | PLA STR | PLA 2 | PLA STR | 130° C.-210° C. |
| FIG. 1I | PLA 1 | PLA STR | PLA STR | PLA 2 | 130° C.-210° C. |

The PLA1 compound may, for example, be polylactic acid marketed by Natureworks under the reference 6100D with a melting point between 165 and 180° C. or 6202D with a melting point between 155-170° C. The PLA 2 compound may, for example, be polylactic acid marketed by the same company under the reference 6302D with a melting point of between 125-135° C. To obtain fibers comprising a stereocomplex, it is, for example, possible to use a dry-blend of polylactic acid PLA1 with a compound enriched in dextrorotatory polylactic acid.

Due to the presence of the stereocomplex in the fibers, the nonwoven webs according to the invention exhibit improved mechanical properties at elevated temperatures. Such webs can be exposed to hot or boiling water for a relatively long time compared to a nonwoven web of FIG. 1A. We will now describe a process of manufacturing a nonwoven web according to the present invention by taking the example of the nonwoven web illustrated in FIG. 1B, i.e., a nonwoven web having the following composition:
a first layer 1 comprising first fibers having a cross section with a core-sheath structure with a sheath 11 comprising at least 20% by volume of the polylactic acid stereocomplex PLA STR based on the total volume of the first fibers and a core 12 in levorotatory polylactic acid PLA1, and
a second layer 2 comprising second fibers also having a cross section with a core-sheath structure with the core 22 and sheath 21 in levorotatory polylactic acid PLA 1.

To form two-components or single-component fibers with a cross section having a core-sheath structure, a spun bonding device is often equipped with a pair of extruders, one of which allows the core to be formed and the other allows the sheath to be formed.

Thus, to manufacture a nonwoven according to the example illustrated in FIG. 1B, there is provided a spun bonding device with two sets of extruders, one dedicated to the first layer and a second dedicated to the second layer. Ext 11 and Ext 12 designate the extruders which form the first fibers of the first layer and Ext 21 and Ext 22 the extruders which form the second fibers of the second layer.

Initially, according to a step a1/, the extruders Ext 12, Ext 21 and Ext 22 are supplied from a same storage silo comprising levorotatory polylactic acid granules PLA1 via hoppers for each of the extruders. The extruder Ext 11 is supplied from a separate silo comprising granules of a dry-blend of a levorotatory polylactic acid polymer and a dextrorotatory polylactic acid polymer.

It is possible to have the PLA1 and the dry-blend in powder form.

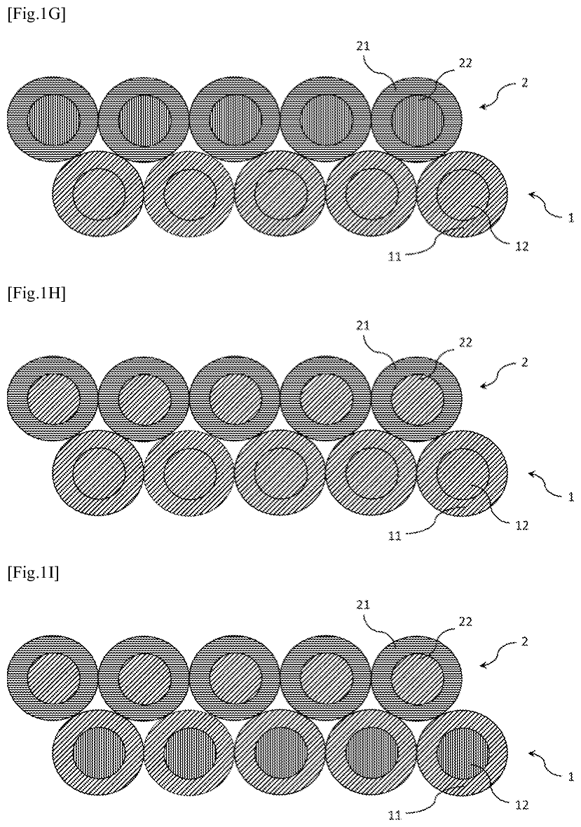

Then, according to a step a2/, the granules are melted in the extruders Ext 11, Ext 12, Ext 21 and Ext 22 and the molten materials are conveyed to two spinneret assemblies 31, 32 with two supply lines for each (not shown in FIG. 3). The first assembly 31 is supplied by two lines, one for each extruder Ext 11 and Ext 12. This assembly makes it possible to form fibers with a sheath comprising a polylactic acid stereocomplex and a core with a polylactic acid PLA1. Similarly, the second assembly is supplied by two lines, one for each extruder Ext 21 and Ext 22. This assembly makes it possible to form fibers with a core and a sheath of polylactic acid PLA1.

A core-sheath structure may be obtained, for example, through the use of distribution plates defining a channel for each of the core-sheath portions of the fibers at the spinnerets and more specifically at the spinning heads.

The fibers leaving the assemblies are then partially cooled and drawn according to a step a3/. Partial cooling is commonly referred to as “quenching”. It is often implemented by means of an air jet (not shown in FIG. 3). The partially cooled fibers are drawn to obtain the desired diameter. The drawing can be done by pneumatic means which allows the fibers to be sucked and directed. The pneumatic means preferably uses an air jet.

After step a3/, according to a step a4/, the fibers are deposited on a belt conveyor 33. In particular, the partially cooled and drawn fibers coming from the extruders 11 and 12, which are designated as the first fibers, are deposited on a belt conveyor 33 which makes it possible to move the first fibers forming the first layer 1 in a machine direction M. The fibers, also partially cooled and drawn coming from the extruders Ext 21 and 22, which are referred to as the second fibers forming the second layer 2, are deposited on the first fibers already on the conveyor belt. The conveyor then conveys the stack of the first layer 1 formed by the first fibers and the second layer 2 formed by the second fibers in the machine direction M.

The stack of the first layer 1 and the second layer 2 is then directed to a calender in order to bond the fibers of the two layers together in a step c/. This step also helps to bond and consolidate the stack. At the end of this step, a nonwoven web assembly according to the present invention is obtained.

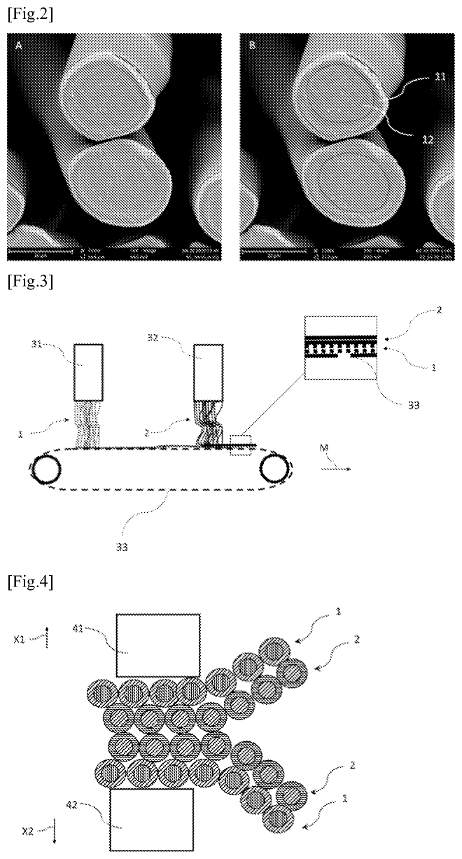

In FIG. 4, the sealing of a food packaging made with a nonwoven web according to the invention was shown. The nonwoven web used is that also represented in FIG. 1I, i.e., a first layer 1 with first fibers having a core PLA 1 and a sheath PLA STR, and a second layer with second fibers having a core PLA 2 and a sheath PLA STR. This nonwoven web has a sealing window between 130° C. and 210° C. The sealing is carried out by means of two hot jaws 41, 42 which apply a compressive force in the directions X1 and X2. The jaws are at a temperature of at least 130° C. The first layer 1, comprising the stereocomplex having a melting and/or softening temperature greater than 210° C., acts as an insulator. The second layer 2, melted and/or softened, makes it possible to create the seal.

The examples described above relate to a nonwoven web having two layers. However, a person skilled in the art may envision more than two layers. They may, for example, add to the spun bonding device one or more extruders dedicated to additional layers.

### EXAMPLES

To facilitate measurements, the samples analyzed consist of a single layer.

Starting raw material:

The materials used are granules:
levorotatory polylactic acid having a melting point of between 165° C. and 180° C., which is referred to as PLAT
a 50/50 dry-blend of levorotatory polylactic acid and dextrorotatory polylactic lactic acid, which is referred to as PLA STR.

Sample manufacturing process:

After drying at 50° C. overnight, the granules are introduced into a spun bonding device so as to form a nonwoven web with fibers having a core-sheath structure. The core-to-sheath volume ratio was varied from 50/50 to 70/30.

The air temperature for partial cooling is set at 15° C. and the air jet for spinning has a pressure equal to 0.3 MPa. The samples have a basis weight of approximately 24 g/m².

The dedicated core extruder operates at a temperature of 225° C. at the inlet and a temperature of 250° C. at the outlet. The dedicated sheath extruder operates at a temperature of 170° C. at the inlet and 200° C. at the outlet.

The fibers are bonded by calendering at a temperature of 155° C. and at a pressure of 120 kN/m.

Different characterization tests:

The nonwoven webs were analyzed with a device for measuring the resistance to heat or “hot tack”. This device is used to seal and peel nonwoven webs and measure peel strength. This strength may be measured either just after sealing while the nonwoven web is still hot, or after a few seconds when the nonwoven web is at room temperature. The test parameters are as follows:
sealing temperature: from 160° C. to 180° C.,
sealing pressure: 0.1 N/mm²,
sealing time: 5 s,
cooling time: 1 s,
peeling speed: 100 mm/s,
sample width: 15 mm

The results of the heat resistance test are summarized in Table 2, where appropriate the values of the peel strength are shown in the table. These values are expressed in Newtons.

TABLE 2

| | | | | Sealing temperature and time | | | | | |
|---|---|---|---|---|---|---|---|---|---|
| | | | | 160° | 163° | 165° | 168° | 170° | 180° |
| Sam- | | | Ratio | C. | C. | C. | C. | C. | C. |
| ple | Core | Sheath | C/S | (10 s) | (10 s) | (10 s) | (10 s) | (10 s) | (10 s) |
| 1 | PLA1 | PLA1 | NA | PS | 0.43 | 1.8* | SF | SF | SF |
| 2 | PLA | PLA1 | 50/50 | PS | PS | 0.41 | 2.54* | SF | SF |
| | STR | | | | | | | | |
| 3 | PLA | PLA1 | 60/40 | PS | PS | 0.49 | 2.35* | SF | SF |
| | STR | | | | | | | | |
| 4 | PLA | PLA1 | 70/30 | PS | PS | 0.25 | 1.27 | 2.46 | SF |
| | STR | | | | | | | | |

In Table 2, the PS boxes mean that there was no seal and the SF boxes mean a melt seal. Values with a star (*) are those for which there has been a slight tearing. It should be noted that the addition of the stereocomplex in the core of the fibers makes it possible to move the sealing window towards high temperatures. In addition, the peel strength is increased for samples comprising the stereocomplex. The samples according to the invention, i.e., samples 2, 3 and 4, are therefore less likely to melt during sealing at a high temperature and are those which have better peel strength.

Samples were also tested by a heat seal process on a Brugger device. This process consists of sealing a sample on itself by placing it between two heated jaws. Then, the seal is evaluated before and after 30 minutes of immersion in boiling water.

The sealing parameters are as follows:
jaws temperatures: 120, 130, 140, 150, 160, 165, 170, 175, 180, 185, 190, 195, 200, 210, 215 and 220° C.,
pressure: 2 bars,
sealing time: 0.5 s.

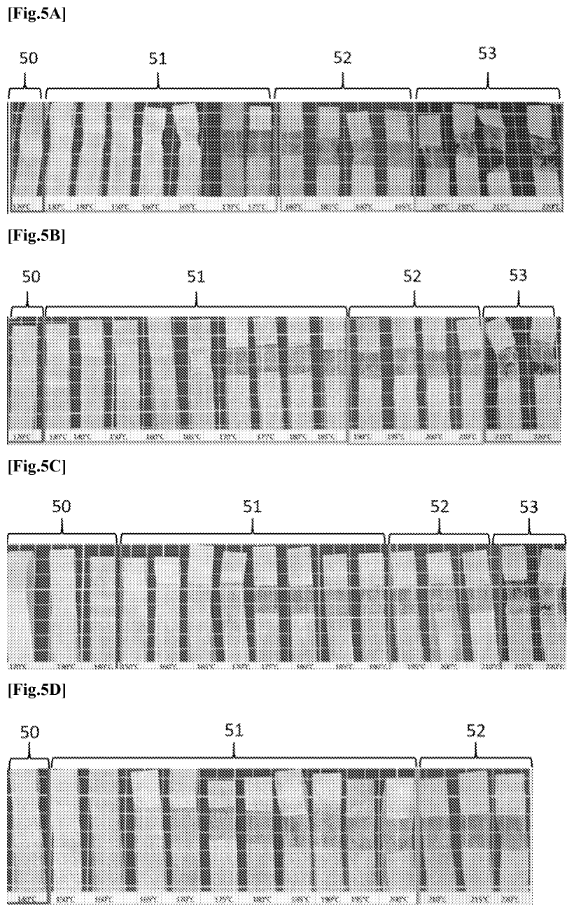

The samples obtained after sealing are shown in FIGS. 5A to 5D. Zones 50, 51, 52 and 53 respectively represent samples for which there is no seal, acceptable seal, melt seal, and tear seal. These results also show that there is a displacement of the sealing window towards high temperatures. The sample comprising fibers with a PLAT core-sheath structure degrades substantially at a temperature above 200° C. However, Sample 4 with fibers comprising 70% PLA STR is resistant up to 220° C.

In order to assess the strength of the seal in boiling water, samples 1 and 4 are sealed at different temperatures, shown in Table 3, and then immersed for three hours in boiling water. Table 3 summarizes the results obtained, the designations (O), (OP) and (S) respectively denote opening of the seal, partial opening of the seal and seal maintained.

TABLE 3

| | Seal strength | | | | |
|---|---|---|---|---|---|
| Sample | Low | | | Average | High |
| 1 | 154° C. (O) | | | 158° C. (OP) | 162° C. (S) |
| 4 | 154° C. (O) | 158° C. (OP) | 162° C. (S) | 168° C. (S) | — |

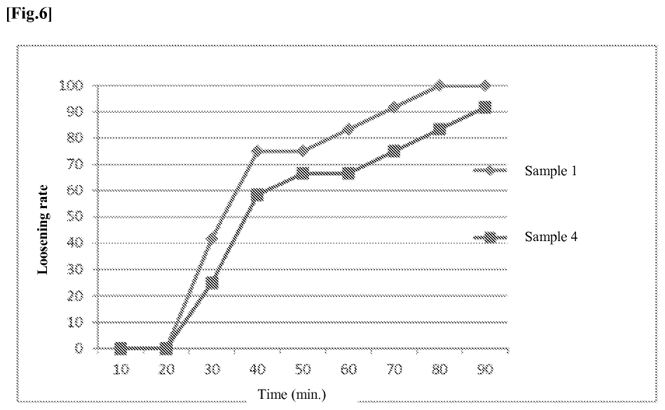

Samples 1 and 4 with twelve sealing points were also immersed in boiling water to assess the loosening rate over time. Sample 1 is sealed at 154° C. and Sample 4 at 158° C. in order to have close seal strength. The results of this test are shown in FIG. 6. This result shows that Sample 4 comprising PLA STR exhibits a seal which is more resistant to boiling water than Sample 1 comprising only PLA 1. Thus, a food packaging comprising a nonwoven web according to the present invention can be submerged in boiling water for a relatively long time.

1. A heat-resistant nonwoven web produced by melt-bonding, in particular by spun bonding, comprising at least:
a first layer comprising first fibers; and
a second layer comprising second fibers;
wherein at least one of the first fibers of the first layer or of the second fibers of the second layer comprise a polylactic acid stereocomplex representing at least 20% by volume of the total volume of the first or second fibers.

2. The heat-resistant nonwoven web according to claim 1, characterized in that at least one of the first fibers or of the second fibers comprise a cross-section having a structure chosen from a core-sheath structure, eccentric core-sheath or islands-in-the sea structure.

3. The heat-resistant nonwoven web of claim 1, characterized in that at least one of the first fibers or of the second fibers is a single-component fiber.

4. The heat-resistant nonwoven web of claim 1, characterized in that at least one of the first or second fibers are bicomponent fibers having in section a first portion and a second portion.

5. The heat-resistant nonwoven web of claim 4, characterized in that at least one of the first fibers or of the second fibers comprise:
the first portion comprising a polylactic acid stereocomplex representing between 20 and 80% by volume, preferably between 30 and 70% by volume, and more preferably 50% by volume of the total volume of the first or second fibers, and
the second portion comprising a second polymer representing between 20 and 80% by volume, preferably between 30 and 70% by volume, and more preferably 50% by volume of the total volume of the first or second fibers, the second polymer being also chosen from polyhydroxyalkanoates, polyesters or their copolymers, polyesters being chosen in particular from polylactic acids with the exception of polylactic acid stereocomplexes, polybutylene succinates, polybutylene succinate co-adipates, polycaprolactones, polybutyrate adipate terephthalates.

6. The heat-resistant nonwoven web of claim 1, characterized in that at least one of the first or second fibers have a diameter of less than 30 μm.

7. The heat-resistant nonwoven web of claim 1, characterized in that it has a porosity of between 1,000 l/m²/min and 9,000 l/m²/min.

8. A process of manufacturing a heat-resistant nonwoven web of claim 1, said process comprising the following steps:
a/supplying a device operating by the melt-bonding process, with at least one dry-blend of a polymer of levorotatory polylactic acid and a dextrorotatory polylactic acid polymer so as to form at least one fiber of the first or second layer;
b/where appropriate, supplying at least one fiber of the first layer or of the second layer not formed in step a/;
c/assembly of the first and the second layers, at least one of which being formed in step a/and, where appropriate, provided in step b/.

9. The process of manufacturing a heat-resistant nonwoven web of claim 8, wherein during step a/ the dry-blend has a volume ratio between the levorotatory polylactic acid polymer and the dextrorotatory polylactic acid polymer between 65/35 and 35/65.

10. The process of manufacturing a heat-resistant nonwoven web of claim 8, wherein step c/ is implemented in the device operating by the melt-bonding process during a bonding step.

11. A food packaging intended to be immersed in an aqueous solution having a temperature of at least 90° C., comprising a heat-resistant nonwoven web according to claim 1.

12. The heat-resistant nonwoven web according to claim 1, characterized in that at least one of the first fibers or of the second fibers comprise a cross-section having a core-sheath structure.

13. The heat-resistant nonwoven web of claim 4, characterized in that at least one of the first fibers or of the second fibers comprise:
the first portion comprising a polylactic acid stereocomplex representing between 30 and 70% by volume, or 50% by volume of the total volume of the first or second fibers, and
the second portion comprising a second polymer representing between 30 and 70% by volume, or 50% by volume of the total volume of the first or second fibers, the second polymer being also chosen from polyhydroxyalkanoates, polyesters or their copolymers, polyesters being chosen in particular from polylactic acids with the exception of polylactic acid stereocomplexes, polybutylene succinates, polybutylene succinate co-adipates, polycaprolactones, polybutyrate adipate terephthalates.

14. The heat-resistant nonwoven web of claim 1, characterized in that at least one of the first or second fibers have a diameter of between 12 and 20 μm.

15. The process of manufacturing a heat-resistant nonwoven web of claim 8, wherein the device is a spun bonding device.

16. The process of manufacturing a heat-resistant nonwoven web of claim 8, wherein during step a/ the dry-blend has a volume ratio between the levorotatory polylactic acid polymer and the dextrorotatory polylactic acid polymer between 60/40 and 40/60, or between 55/45 and 45/55.

17. The process of manufacturing a heat-resistant nonwoven web of claim 10, wherein the bonding step is a calendering step.
